(19) United States
(12) Patent Application Publication
(10) Pub. No.: US 2017/0193385 A1
(43) Pub. Date: Jul. 6, 2017

(54) Configurable Dialog System

(71) Applicant: Nuance Communications, Inc., Burlington, MA (US)

(72) Inventor: Richard Beaufort, Corbais (BE)

(21) Appl. No.: 15/166,730

(22) Filed: May 27, 2016

Related U.S. Application Data
(60) Provisional application No. 62/273,583, filed on Dec. 31, 2015.

(51) Int. Cl. G06N 7/00; G06F 17/28; G06F 17/30

(52) U.S. Cl. CPC G06N 7/005; G06F 17/30867; G06F 17/30929; G06F 17/30976; G06F 17/28

(57) ABSTRACT

Various implementations described herein are directed to a method for generating an instance of a finite state machine. The method may receive a configuration comprising a value for each of one or more configuration points of a finite state machine. The method may determine a configuration point of the finite state machine that is not defined with a value in the configuration. The method may determine a default value for the determined configuration point of the finite state machine that is not defined with a value in the configuration. The method may also generate, based on the configuration and the default value, an instance of the finite state machine. The instance of the finite state machine collects data using a dialog system.

### CROSS REFERENCE TO RELATED APPLICATIONS

The present application claims the priority benefit of U.S. Provisional Patent Application No. 62/273,583, filed Dec. 31, 2015, entitled Configurable Dialog System. The patents and patent applications listed in this paragraph are hereby incorporated by reference in their entireties.

### BACKGROUND

Transactional dialog systems collect pieces of information from a user and perform various tasks for the user with the collected information. For example, a transactional dialog system may be used make a restaurant reservation. Typically, when software is programmed to collect data using a dialog system, a separate implementation of the dialog system must be programmed repeatedly for each of the pieces of data to collect, despite the fact that the various implementations of the dialog system may perform similar functions.

Coding and maintaining the implementations of the dialog system may be time consuming because each implementation of the dialog system must be managed individually. For example, if a method of accessing a database is modified, and multiple implementations of a dialog system within an application access the database, then each of the implementations of the dialog system that access the database will be modified to use the new method of accessing the database. Errors may be more likely to be introduced due to the multiple implementations and increased complexity of the dialog system.

A user may experience different behaviors, either in various places of the same application or in various different applications, when a transactional dialog system is programmed repeatedly. Interactions between the user and the dialog system may be inconsistent. The different behaviors of the implementations of the dialog system may disturb the user or discourage the user from continuing the dialog. This may result in a decrease in user retention for the dialog system.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed to a configurable dialog system. Rather than programming a dialog system separately for each piece of data to be collected, a configuration may be provided and used to generate an instance of a dialog system. The configurable dialog system may use a finite state machine (FSM) to collect and process data.

The configurable dialog system may have configuration points for which code may be provided to customize each generated instance of the dialog system. By using the configurable dialog system, an application may provide a consistent dialog interface for collecting information from a user. The configurable dialog system may allow users to input information in any order.

A configuration file describing one or more instances of the FSM may be provided in the resources of a software application. When the software application is opened, instances of the FSM may be automatically generated based on the configuration file. The software application may then collect data via a dialog input provided by the generated instances of the FSM.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 illustrates an example operating environment that may be used to implement one or more illustrative aspects of the disclosure.

FIG. 2 illustrates a task tree diagram according to one or more illustrative aspects of the disclosure.

FIG. 3 is a flow diagram of a method for a dialog system according to one or more illustrative aspects of the disclosure.

FIG. 4 is a graph of a finite state machine (FSM) for a dialog system according to one or more illustrative aspects of the disclosure.

FIG. 5 is a flow diagram of a method for generating an instance of an FSM according to one or more illustrative aspects of the disclosure.

FIG. 6 is a flow diagram of a method for collecting complex data using an FSM according to one or more illustrative aspects of the disclosure.

### DETAILED DESCRIPTION

In the following description of the various embodiments, reference is made to the accompanying drawings, which form a part hereof, and in which is shown by way of illustration various embodiments in which aspects described herein may be practiced. It is to be understood that other embodiments may be utilized and structural and functional modifications may be made without departing from the scope of the described aspects and embodiments. Aspects described herein are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

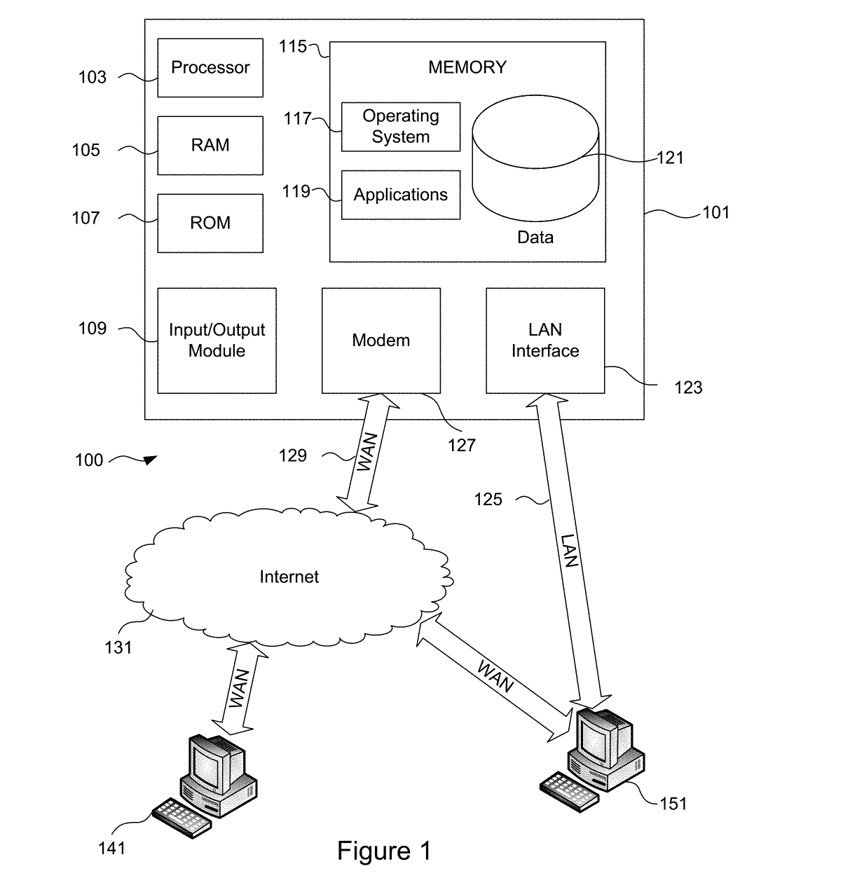

FIG. 1 illustrates an example operating environment that may be used to implement one or more illustrative aspects of the disclosure. Computer system 101, for example, a computer server, smart phone, laptop, tablet, or other computerized device, is illustrated in a communication system 100. The system 101 may have a processor 103 for controlling overall operation of the system 101 and its associated components, including RAM 105, ROM 107, input/output (I/O) module 109, and memory 115.

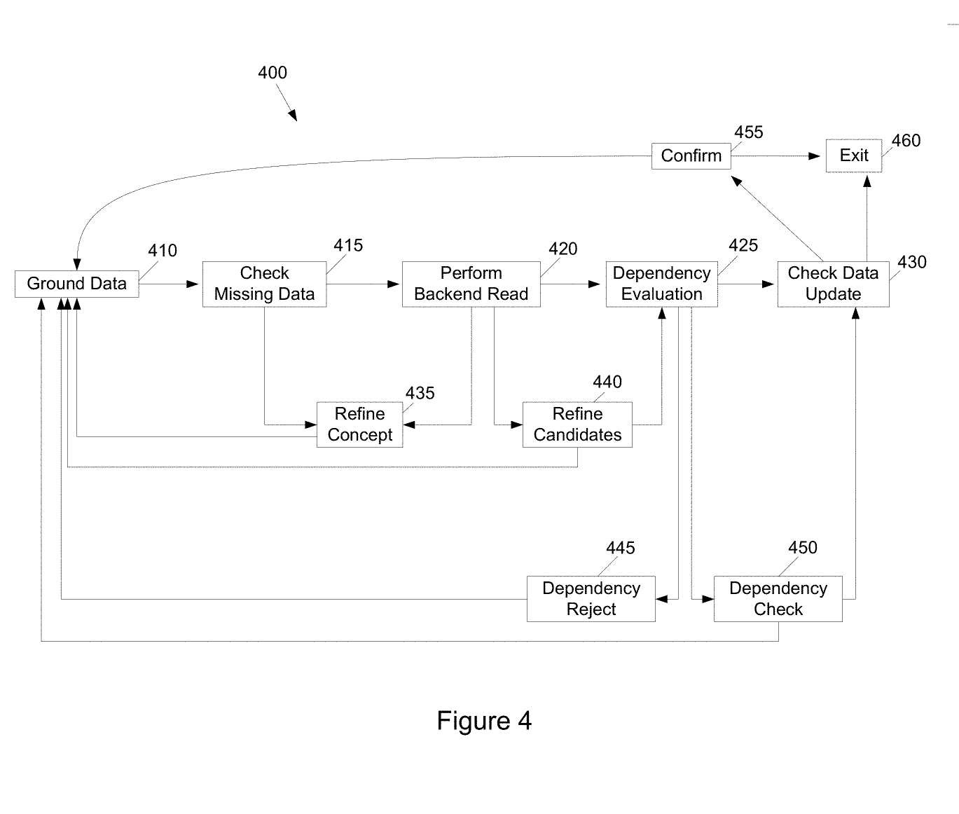

I/O module 109 may include a microphone, keypad, touch screen, and/or stylus through which a user of the system 101 may provide input, and may also include one or more of a speaker for providing audio output and a video display device for providing textual, audiovisual and/or graphical output. In one implementation, I/O module 109 may be used to receive input and provide output for a dialog system, such as a dialog system implemented using the finite state machine (FSM) described below and in FIG. 4. Software may be stored within memory 115 or other storage to provide instructions to processor 103 for enabling the system 101 to perform various functions. For example, memory 115 may store software used by the system 101, such as an operating system 117, application programs 119, and an associated database 121. Processor 103 and its associated components may allow the system 101 to run, i.e., execute, a series of computer-readable instructions.

The system 101 may operate in a networked environment supporting connections to one or more remote computers, such as terminals 141 and 151. The terminals 141 and 151 may be personal computers or servers that include many or all of the elements described above relative to the system 101. The network connections depicted in FIG. 1 include a local area network (LAN) 125 and a wide area network (WAN) 129, but may also include other networks. When used in a LAN networking environment, the system 101 is connected to the LAN 125 through a network interface or adapter 123. When used in a WAN networking environment, the system 101 may include a modem 127 or other means for establishing communications over the WAN 129, such as the internet 131. It will be appreciated that the network connections shown are illustrative and other means of establishing a communications link between the computers may be used. The existence of any of various well-known protocols such as TCP/IP, Ethernet, Wi-Fi, FTP, HTTP and the like is presumed.

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, and distributed computing environments that include any of the above systems or devices, and the like.

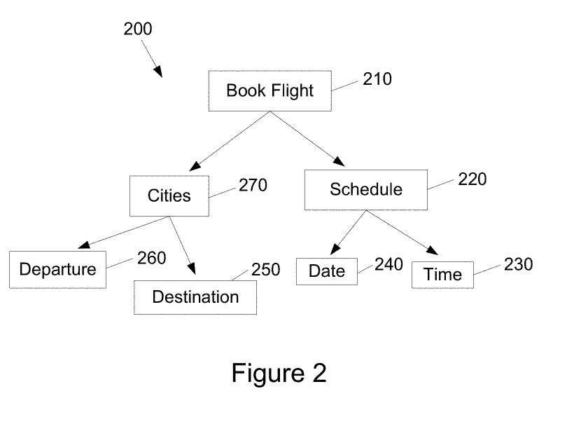

FIG. 2 illustrates a diagram of a task tree 200 according to one or more illustrative aspects of the disclosure. A dialog system executing on the system 101 may collect the data described in the task tree 200. The task tree 200 comprises a collection of nodes 210-70 corresponding to data to be collected for a flight booking task. The task tree 200 may represent data collections steps of a transactional dialog system for booking the flight. The individual nodes 210-70 in the task tree 200 either collect data or organize the collection of other nodes.

Node 260 may collect a departure city, node 250 may collect a destination city, node 240 may collect a departure date, and node 230 may collect a departure time. For example, a departure time for node 230 may be collected by the dialog system asking “when do you want your flight?” The data collected by nodes 230-60 may comprise scalar data.

Node 270 organizes the city data collected by nodes 250 and 260, and node 220 organize the schedule data collected by nodes 230 and 240. Node 210 may be a root node. The root node 210 may execute the booking flight task when the children nodes 220-70 have completed their tasks. In this example, after the departure, destination, date, and time are collected, the node 210 may execute to book a flight. The nodes 210, 220, and 270 may collect complex data.

In one implementation, the data may be collected by the nodes in any order. For example, a user may first provide a departure city and then a destination city, or the user may first provide the destination city and then the departure city. The root node 210 may execute when each of the nodes 230-60 has collected data, regardless of the order in which the nodes 230-60 collect the data. In another example, a user may begin the data collection process by stating “I want a flight for next Thursday morning please.” In this example, the user has provided data for nodes 230 and 240.

A variety of collection steps may be used when collecting data to complete the task tree 200. The collection steps may include, among others, grounding data, performing a backend access, performing a refinement, or resolving a dependency. These collection steps are further described in method 300.

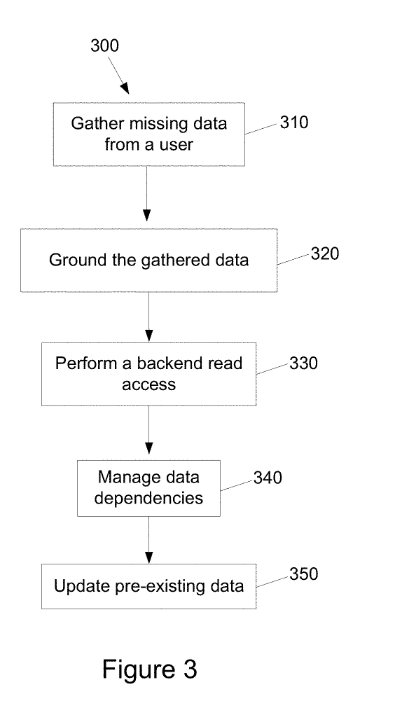

FIG. 3 is a flow diagram of a method 300 for a dialog system according to one or more illustrative aspects of the disclosure. In one or more embodiments, the method 300 or one or more steps thereof may be performed by one or more computing devices or entities. For example, portions of the method 300 may be performed by components of the computer system 101. The method 300 or one or more steps thereof may be embodied in computer-executable instructions that are stored in a computer-readable medium, such as a non-transitory computer-readable medium. The steps in method 300 might not all be performed in the order specified and some steps may be omitted or changed in order.

At step 310, missing data may be gathered from a user. For example, if the method 300 corresponds to the flight booking task in task tree 200, the missing data may comprise a departure city, a destination city, a departure date, or a departure time. The missing data may be gathered at step 310 using a voice input, text input, user selections, or combinations thereof.

The dialog or information that initiated the dialog collection may comprise all of the missing data. For example, if a user said “I want to fly from Boston to Chicago at ten in the morning on Tuesday,” then no further information might be needed to book a flight. If further data is needed, the dialog system may ask questions to gather the further data at step 310. Data to be collected by the dialog system may be mandatory or optional. The extra questions may be asked until all of the mandatory data is collected. For example, for a task to add a contact to an address book, a first name and a last name of the contact to add may be mandatory, but an email address may be optional. In this example, if a user only provides a first name, the dialog system may request that the user input a last name, but the dialog system might not request that the user input an email address.

In one implementation, a refinement process may receive a list of missing attributes, which may be referred to as spawned concepts. In this implementation, the user may be asked to provide data for the missing attributes, and the refinement process may then send the collected data to a data collection process that will validate the data.

At step 320, the data gathered at step 310 may be grounded, i.e., adapted or modified so that it can be used in the dialog system. A relative, or conceptual, piece of data may be grounded so that it can be used by the dialog system to perform a task. For example, if a dialog system is being used to schedule a meeting, and the user states that the meeting should occur “in two hours,” the dialog system may ground this piece of data by determining a time that is two hours from the current time, and scheduling the meeting at that determined time.

In tree 200, the grounding step 320 may be performed on data collected for nodes 230 and 240 if the date or time is given in a relative format. For example, if a user states that they want a flight “tomorrow”, the grounding step 320 may convert “tomorrow” to a date.

Portions of step 310 and 320 may be performed simultaneously, repeatedly, or in any order. For example, if a user states that a meeting should be scheduled “in the morning” at step 310, step 320 may determine that the meeting is to occur in the AM, but step 310 may then performed again to ask the user for an exact time.

At step 330, a backend read access may be performed based on data provided by the user. The backend read access performed at step 330 may comprise retrieving data from a database, or from another source. The backend read access may be performed based on the results of steps 310 or 320. For example, if a user says “call Jane” at step 310, a backend read access may be performed to retrieve all contacts named Jane from a database for an address book. For a dialog system corresponding to tree 200, the backend read access step 330 may be performed to retrieve a list of potential flights that correspond to the data collected by nodes 230-60.

The backend read at step 330 may be performed when missing data has been requested by a user. If multiple candidates are retrieved at step 330, the user may be asked to select one of the retrieved candidates. Alternatively, if there are no retrieved candidates, the user may be asked to cancel the task or enter additional data. These actions may be referred to as a refinement or a rejection.

The refinement may allow a user to select from multiple options, or refine the collected data. In one example of a refinement for the task tree 200, if no flights are retrieved by a backend access performed for node 210, the refinement may be performed by asking the user to change one or more of the data collected for nodes 230-60. In another example of a refinement for the task tree 200, if multiple flights are retrieved by the backend access, a list of the retrieved flights may be displayed to the user for the user to select one of the flights.

In certain instances, the method 300 may proceed directly from step 320 to step 340. For example, if the dialog system is performing an add contact task, the read access might not be performed because the system is adding data to an address book, not retrieving or modifying data in an address book.

At step 340, data dependencies may be managed. Managing data dependencies may comprise resolving dependency conflicts or resolving a constraint that prevents the dialog system from using collected data. Dependency conflicts may exist with the task itself, or between collected data. An example of a dependency conflict with the task itself is, for a task to initiate a phone call, when a contact is provided but the contact has no phone number. In this case, the collected data, i.e., the contact name, should be rejected. An example of a dependency conflict between different collected data is, for a food ordering task, if a user requested a vegetarian pizza with bacon. In this example of the dependency conflict between different collected data, rather than rejecting the collected data, the dialog system should ask the user whether they want to maintain the input.

In tree 200, dependencies may be resolved by step 340 when determining a departure city for node 260 and a destination city for node 250. If the departure city collected for the node 260 or the destination city collected for node 250 does not have an airport, the nearest airport to the inputted city may be determined at step 340. Additionally, there may be a constraint that the departure city and arrival city should be different, and this dependency may be resolved, for node 270, at step 340.

At step 350 pre-existing data may be updated. The pre-existing data may be data that is stored in a database. For example, the pre-existing data updated at step 350 may be stored in the database accessed at step 330. In one implementation, prior to updating the data, the dialog system may ask the user to confirm the update.

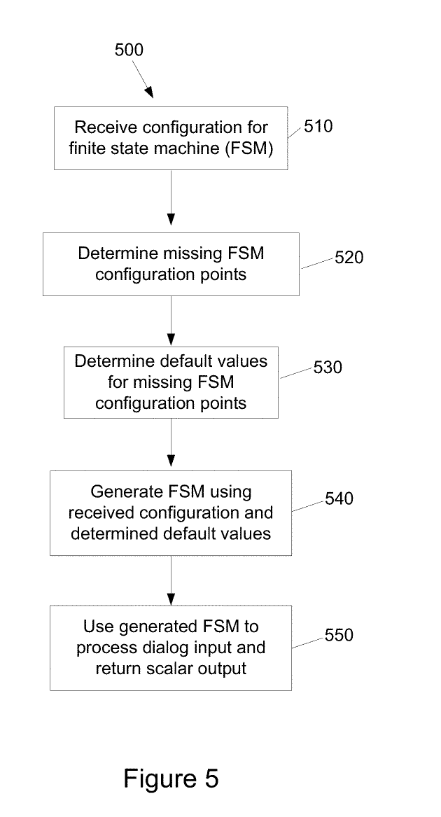

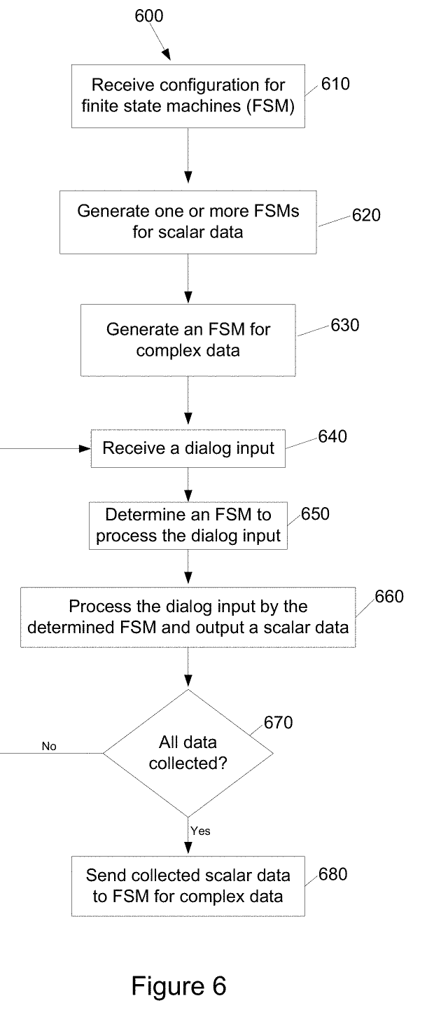

An FSM, such as the FSM 400, may perform all or a portion of the actions described in method 300. An instance of the finite state machine may be generated, based on a configuration, to collect data. The configuration based dialog system may be more efficient, reliable, and consistent than coding multiple implementations of a dialog system individually. In the configuration based dialog system, a configuration file is provided, and instances of the dialog system are generated based on the configuration file to process dialog input. FIGS. 5 and 6 describe methods of generating instances of a finite state machine to create a transactional dialog system.

In the configuration based dialog system, the same collection strategy may be used regardless of the data to be collected. The configuration based dialog system may comprise a series of configuration points used to customize instances of the FSM 400 for individual pieces of data to be collected. Preset values of the configuration points may be provided for data that is frequently collected by transactional dialog systems, such as dates and times.

FIG. 4 is a graph of an FSM 400 for a dialog state machine according to one or more illustrative aspects of the disclosure. The FSM 400 may be implemented as a software program, or as a portion of a software program. The states 410-60 of the FSM 400 may comprise one or more steps of the method 300. The FSM 400 may be generated using the methods 500 and 600, described below and in FIGS. 5 and 6.

Each state 410-60 of the FSM 400 may have a default behavior. When an instance of the FSM 400 is generated, if no configuration is provided for a state 410-60 in the FSM 400, then the state 410-60 may perform the default behavior.

State 410 is a ground data state. The ground data state 410 may be the input state of the graph. When the FSM 400 is at the ground data state 410, input may be received via a dialog interface. The input may then be grounded as described above at step 320 of method 300. In one implementation, the ground data state 410 may be the only input state of the FSM 400.

After input is received and grounded at the ground data state 410, the FSM 400 may transition to the check missing data state 415. At state 415, the data determined by state 410 may be compared to a listing of mandatory attributes. The listing of mandatory attributes may be provided in a configuration for an instance of the FSM 400. If the mandatory attributes are present in the grounded data from state 410, then the FSM 400 may transition to the perform backend read state 420. If one or more mandatory attributes are missing from the grounded data from state 410, then the FSM 400 may transition to the refine concept state 435 to collect additional data. In one implementation, rather than transitioning to the refine concept state 435 from the check missing data state 415, the FSM 400 may transition to the dependency reject state 445, which is described below.

At the perform backend read state 420, data may be retrieved from a database based on the data determined at state 410. The default behavior of the perform backend read state 420 may be to create a list containing the data determined at state 410. The configuration may describe other behaviors to be performed, instead of the default behavior, at state 420. For example, the configuration may comprise instructions to access a database at state 420. The configuration may also indicate a minimum number of candidates, a maximum number of candidates, or a threshold for a refinement by candidates. The default value for the threshold for a refinement by candidates may be undefined, i.e., there is no default threshold for refinement by candidates. The default value for the maximum number of candidates may be 1.

If no candidates are received by the perform backend read state 420, or if the number of candidates that are received is less than the minimum number of candidates, then the FSM 400 may transition to the refine concept state 435. If the number of candidates that are received by the perform backend read state 420 is greater than the threshold for a refinement by candidates, then the FSM 400 may transition to the refine concept state 435. In one implementation, rather than transitioning from the perform backend read state 420 to the refine concept state 435, the FSM 400 may transition to the dependency reject state 445, which is described below.

At the refine concept state 435, new data is received. The refine concept state 435 may collect missing attributes or request a new value. For example, if the backend read access at state 420 returned no results, then a new value may be requested at state 435. After collecting the new data, the FSM 400 may transition to the ground data state 410 to process the new data. In one implementation, the refine concept state 435 might not be configurable.

If the number of candidates returned by the perform backend read state 420 is greater than the maximum number of candidates, the FSM 400 may transition to the refine candidates state 440. At the refine candidates state 440, one or more candidates may be selected from those retrieved at the perform backend read state 420. If the maximum number of candidates is 1, then a disambiguation may be performed. For example, the user may select one candidate from the candidates returned by the perform backend read state 420. If the maximum number of candidates is greater than one, then a selection may be performed instead of the disambiguation. For example, if the maximum number of candidates is three, the user may select up to three candidates from the candidates returned by the perform backend read state 420.

At the refine candidates state 440, after a user has made selections, it may be determined if the number of selected candidates is still greater than the maximum number of candidates. If the number of selected candidates is greater than the maximum number of candidates, then further refinement may occur at the refine candidates state 440 until the number of selected candidates is less than or equal to the maximum number of candidates. When the number of selected candidates is less than or equal to the maximum number of candidates, the FSM 400 may transition to the dependency evaluation state 425.

While the FSM 400 is at the refine candidates state 440, a user may provide a new value for a concept rather than refining the candidates. When a new value is provided at the refine candidates state 440, then the FSM 400 may transition to the ground data state 410 to process the new value. In one implementation, the dialog system may automatically detect that a new value is provided and transition the FSM 400 to the ground data state 410. For example, for a retrieve contact task, if a list of candidates with the name “Joe” is presented, and the user says “No, I said Joel,” then the FSM 400 may transition to the ground data state 410 to process the “Joel” input.

As described above, after the refine candidates state 440 or perform backend read state 420, the FSM 400 may transition to the dependency evaluation state 425. The default behavior of the dependency evaluation state 425 may be to accept the collected value and proceed to the check data update state 430. Actions similar to those described above at step 340 of method 300 may be performed at the dependency evaluation state 425.

If it is determined, at state 425, that there are broken dependencies, then the FSM 400 may transition to the dependency reject state 445. For example, in a task to book a flight, if a city without an airport is entered as the destination, then the FSM may transition from the dependency evaluation state 425 to the dependency reject state 445. If, at state 425, a dependency check is requested, then the FSM 400 may transition to the dependency check state 450. For example, for a task to add a contact to an address book, if the user enters “John” for the first name and “John” for the last name, the FSM 400 may transition to the dependency check state 450 to confirm that the user intended to add a contact named “John John” to their address book. Otherwise, if the value is accepted as is at state 425, then the FSM 400 may transition to the check data update state 430. For example, if, at state 425, there are no detected broken dependencies and it is determined that no dependency check should be performed, then the FSM 400 may transition to the check data update state 430.

At the dependency reject state 445, the user may provide new data to be processed by the FSM 400. After the new data is received, the FSM 400 may transition from the dependency reject state 445 to the ground data state 410. In one implementation, the dependency reject state 445 and the refine concept state 435, which is described above, may be combined. For example, in this implementation, the combined state may request new data from the user and, when the new data is received, the FSM 400 may transition to the ground data state 410.

At the dependency check state 450, the user may either change or confirm a value. For example, the user may change a value as suggested by the FSM 400. If the value is changed, the FSM 400 may transition to state 410 to ground the received value. If the user confirms the value, the FSM 400 may transition to the check data update state 430.

The check data update state 430 may determine if the user has requested to update data. For example, if a user has requested to add a phone number to a contact in an address book, the check data update state 430 may determine that an update is to be performed. If it is determined, at the check data update state 430, that an update is to be performed, then the FSM 400 may transition from the check data update state 430 to the confirm state 455. Otherwise, if it is determined at the check data update state 430 that no data update is to be performed, then the FSM 400 may transition to the exit state 460 because the data collection process is finished.

At the confirm state 455 a user may either confirm the data update or reject the data update. For example, a confirmation screen describing the update may be displayed and the user may select to confirm or reject the update. If the data update is confirmed the FSM 400 may transition from the confirm state 455 to the exit state 460. If the data update is rejected at state 455 then the FSM 400 may transition to the ground data state 410.

In one implementation, the FSM 400 may be implemented without the check data update state 430. In this implementation, the FSM 400 may transition from the dependency evaluation state 425 to the exit state 460, and the FSM 400 may transition, from the dependency check state 450 and when a user confirms the value, to step 460.

Although the FSM 400 is described here as comprising a particular set of states, the FSM 400 may comprise any number of states, such as a subset of the states illustrated in FIG. 4, or additional states. In one implementation, the FSM 400 might not comprise states 430, 435, and 455.

FIG. 5 is a flow diagram of a method 500 for generating an instance of the FSM 400 according to one or more illustrative aspects of the disclosure. In one or more embodiments, the method 500 or one or more steps thereof may be performed by one or more computing devices or entities. For example, portions of the method 500 may be performed by components of the computer system 101. The method 500 or one or more steps thereof may be embodied in computer-executable instructions that are stored in a computer-readable medium, such as a non-transitory computer-readable medium. The steps in method 500 might not all be performed in the order specified and some steps may be omitted or changed in order.

At step 510, a configuration for generating an instance of the FSM 400, or another FSM for dialog input, may be received. In one implementation, the configuration may be in an Extensible Markup Language (XML) format. In this implementation, the configuration may be an XML data file corresponding to a document type definition (DTD) used during one or more steps of the method 300. The configuration may be provided in the resources of an application. The configuration may describe various parameters and behaviors of the method 300, which may be referred to as configuration points.

The parameters may comprise values to be checked within predefined steps. The parameters defined in the configuration may comprise mandatory attributes, a maximum number of candidates, a threshold for a refinement by candidates, and concepts to update. The behaviors may comprise pieces of code specific to the information to be collected. The behaviors described in the configuration may comprise grounding, a backend read, and evaluating dependencies.

The mandatory attributes may comprise attributes that should be collected by the instance of the FSM 400. For example, the check missing data state 415, described above, may determine if the mandatory attributes are present in the collected data. By default, all attributes may be optional. The mandatory attributes may be provided as a list, or a description. For example, the configuration may specify that the departure date collected for the node 240 is a mandatory attribute, and that the type of value to collect is a date.

The maximum number of candidates may describe the maximum number of candidates to keep by the perform backend read state 420 and refine candidates state 440. By default, the maximum number of candidates may be one, which corresponds to a disambiguation. The maximum number of candidates may correspond to a maximum number of scalar values for an instance of the FSM 400 to return.

The threshold for a refinement by candidates may be used by the perform backend read state 420 to determine whether to proceed to the refine candidates state 440 or the refine concept state 435. The default threshold for a refinement by candidates may be undefined, in which case the refine concept state 435 is not reached if one or more candidates are retrieved at the perform backend read state 420. Thus, the default behavior of the FSM 400 is to transition to the dependency evaluation state 425. If a minimum number of candidates or a maximum number of candidates is set in the configuration received at step 510, then the FSM 400 may transition to the state 435 if the number of retrieved candidates is less than the minimum number of candidates, or the FSM 400 may transition to the refine candidates state 440 if the number of retrieved candidates is greater than the maximum number of candidates. As described above, in one implementation states 435 and 445 may be combined. In this implementation, the FSM 400 may transition to the combined state if the number of retrieved candidates is less than the minimum number of candidates.

The concepts to update parameter may comprise a list of concepts to update. The list may be empty by default. Application code may fill in the list of concepts when the task starts based on the user's request. For example, if a user requests “I want to add a phone to Bob Fergusson,” the concept “phone” may be added to the list when the modify contact task is executed. In another example, if a user requests “I want to update Bob Fergusson,” then the name of the concept itself, which in this example is “contact,” may be added to the concept list.

The ground behavior may comprise code that is executed at state 410 to process input. By default, the ground behavior may do nothing. The configuration may comprise code to execute for the ground behavior. For example, if a user inputs “tomorrow,” the configuration may comprise code to convert the input to an actual date.

The backend read behavior may comprise code that is executed at state 420 to perform the backend read. The default behavior for the backend read may comprise creating a list containing one candidate, the collected value. Other behaviors may be implemented in the configuration. For example, the configuration for the backend read behavior may comprise queries for accessing a database.

The evaluate dependency behavior may comprise code that is executed at state 425 to evaluate the collected value. The default behavior for the dependency behavior may be to accept the collected value. Other dependency checking behavior may be implemented in the configuration.

For the date node 240 in task tree 200, a configuration may comprise a piece of code to convert from a relative to an absolute date for the grounding, and a piece of code to check that the day is at least the current day for the check dependency. For the time node 230 in task tree 200, a configuration may comprise a piece of code to convert from relative to absolute time for the grounding, and a piece of code to check that the time is at least the current time for the check dependency. For the destination node 250 in the task tree 200, a configuration may comprise a piece of code to check that the city has an airport and is not the same as the departure location for the check dependency.

Returning to the actions performed by method 500, at step 520, any missing FSM configuration points, such as the behaviors and parameters described above, may be determined. For example, if the configuration received at step 510 does not comprise any grounding behavior, then it may be determined at step 520 that the grounding behavior is missing from the configuration. At step 530, default values for the missing FSM configuration points may be determined. For example, if no maximum number of candidates is provided in the configuration received at step 510, then it may be determined at step 530 that the default maximum number of candidates is one.

At step 540, an instance of the FSM 400 may be generated using the configuration points in the configuration received at step 510 and the default values determined at step 530. For example, an instance of the FSM 400 may be generated to collect a value for the destination node 250 in FIG. 2.

At step 550, the generated instance of the FSM 400 may process dialog input and return a scalar output. For example, if the instance of the FSM 400 is configured to collect a value for the date node 240 in FIG. 2, a user may say “next Monday,” and the instance of the FSM 400 may return the date of the next Monday.

Rather than programming each instance of the FSM 400, or a similar dialog input, a programmer using method 500 may simply provide one or more configuration files to generate instances of the FSM 400. Providing configuration files to generate the instances of FSM 400 rather than implementing each dialog input separately may allow for time and cost savings as well as simplified code maintenance and a lower likelihood of errors being introduced.

FIG. 6 is a flow diagram of a method for collecting complex data using an FSM according to one or more illustrative aspects of the disclosure. In one or more embodiments, the method 600 or one or more steps thereof may be performed by one or more computing devices or entities. For example, portions of the method 600 may be performed by components of the computer system 101. The method 600 or one or more steps thereof may be embodied in computer-executable instructions that are stored in a computer-readable medium, such as a non-transitory computer-readable medium. The steps in method 600 might not all be performed in the order specified and some steps may be omitted or changed in order.

At step 610, a configuration for a plurality of instances of the FSM 400 may be received. The configuration may comprise instructions for generating instances of the FSM 400 for collecting scalar data, such as those generated by method 500. The configuration may also comprise instructions for generating instances of the FSM 400 for collecting complex data. Complex data may comprise one or more scalar data. The instances of the FSM 400 for complex data may receive data from other instances of the FSM 400 rather than receiving any dialog input. For example, a configuration to collect data for the task tree 200 described in FIG. 2 may comprise instances of the FSM 400 for collecting the scalar data described at nodes 230-260, and an instance of the FSM 400 for collecting the complex data described at node 210.

At step 620 one or more instances of the FSM 400 may be generated, based on the configuration, to collect the scalar data. For example, for the task tree 200, an instance of the FSM 400 may be generated for each of the nodes 230, 240, 250, and 260. The instances of the FSM 400 for scalar data may be generated using method 500.

At step 630 one or more instances of the FSM 400 may be generated, based on the configuration, to collect the complex data. For example, an instance of the FSM 400 for the cities node 270 may be generated at step 630 receive input from an instance of the FSM 400, generated at step 620, for the departure node 260 and an instance of the FSM 400, generated at step 620. for the destination node 250.

In one implementation, two or more of the instances of the FSM 400 that are generated at steps 620 and 630 may be combined. For example, the instances of the FSM 400 may be automatically combined by a dialog system. The instances of the FSM 400 may be combined for efficiency purposes or to improve user interactions with the dialog system.

At step 640, a dialog input may be received. The dialog input may be received in response to a prompt. One or more of the instances of the FSM 400 generated at step 620 may be called to collect data. The instances of the FSM 400 may be called in any order. In one implementation, the dialog system may automatically call the instances of the FSM 400 to collect the data, rather than the application designer programming the calls to the individual instances of the FSM 400.

At step 650, an instance of the FSM 400 may be determined to process the dialog input received at step 640. One of the instances of the FSM 400 generated at steps 620 and 630 may be selected to process the dialog input. For example, if instances of the FSM 400 are generated for each node of the task tree 200, and a date is received by the dialog input, then the instance of the FSM 400 that corresponds to the date node 240 may be selected to process the dialog input. In one implementation, the instance of the FSM 400 may be determined by comparing the input received at step 640 to a value in the configuration received at step 610.

At step 660 the dialog input received at step 640 may be processed by the determined instance of the FSM 400. At step 660, the instance of the FSM 400 may output a scalar data. Actions performed at step 660 may be similar to those described at step 550.

At step 670 it may be determined whether all of the scalar data that is described in the configuration has been collected by the instances of the FSM 400. If there is still data to be collected, then the method 600 may return to step 640 to receive further input. If the scalar data has been collected, then the method 600 may proceed to step 680 to send the collected scalar data to an instance of the FSM 400 for complex data. For example, for the task tree 200, if it is determined at step 670 that a departure city, destination city, date, and time have all been collected, then the collected data may be sent, at step 680, to the instance of the FSM 400 corresponding to the book flight node. In this example, the departure city and destination city may be complex data, and these complex data may be resolved first, before proceeding to the next complex level comprising the book flight task.

One or more aspects described herein may be embodied in computer-usable or readable data or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as, but not limited to, HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects, and such data structures are contemplated within the scope of computer executable instructions and computer-usable data described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
receiving, by a processor, a configuration comprising a value for each of one or more configuration points of a finite state machine;
determining, by the processor, a configuration point of the finite state machine that is not defined with a value in the configuration;
determining, automatically by the processor, a default value for the determined configuration point of the finite state machine that is not defined with a value in the configuration; and
generating, by the processor and based on the configuration and the default value, an instance of the finite state machine, wherein the instance of the finite state machine is usable to collect data using a dialog system.

2. The method of claim 1, wherein the configuration comprises instructions to perform a grounding behavior, instructions to perform a backend read behavior, instructions to perform an evaluate dependency behavior, a description of mandatory attributes, a maximum number of candidates to be accepted, a minimum number of candidates to be accepted, a threshold for a refinement on candidates, a description of concepts to update, or combinations thereof.

3. The method of claim 1, wherein the configuration comprises a description of one or more mandatory attributes for data collected by the instance of the finite state machine.

4. The method of claim 3, further comprising:
receiving, by the instance of the finite state machine, a first input;
determining, by the instance of the finite state machine, that the first input does not comprise a mandatory attribute of the one or more mandatory attributes; and
requesting, from a user, and responsive to determining that the first input does not comprise the mandatory attribute, a second input.

5. The method of claim 1, wherein the configuration comprises a maximum number of scalar values for the finite state machine to return.

6. The method of claim 5, further comprising:
receiving, by the instance of the finite state machine and from a user, an input;
retrieving, by the instance of the finite state machine and based on the input, a plurality of candidates based on the input;
determining, by the instance of the finite state machine, that the plurality of candidates comprises a greater number of candidates than the maximum number of scalar values for the finite state machine to return; and
receiving, from the user, a selection of one or more candidates of the plurality of candidates.

7. The method of claim 1, wherein the instance of the finite state machine comprises a ground data state, a check missing data state, a perform backend read state, a dependency evaluation state, and a check data update state.

8. The method of claim 1, wherein the configuration comprises an Extensible Markup Language data file corresponding to a document type definition of the finite state machine.

9. The method of claim 1, wherein the configuration comprises instructions for accessing a database and a maximum number of candidates to be kept from accessing the database.

10. The method of claim 9, further comprising:
receiving, by the instance of the finite state machine, an input; and
retrieving, by the instance of the finite state machine and based on the input, data from the database.

11. The method of claim 1, wherein generating the instance of the finite state machine comprises generating the instance of the finite state machine with a ground data state to receive input.

12. The method of claim 11, wherein generating the instance of the finite state machine comprises generating the instance of the finite state machine with a check missing data state to compare the input to one or more predefined mandatory attributes.

13. A method, comprising:
generating, by a processor and based on a configuration, a plurality of instances of a finite state machine for a dialog system, wherein each instance of the plurality of instances is configured to collect a scalar data;
receiving, by the processor, an input via the dialog system;
determining, by the processor and based on the input, an instance of the plurality of instances of the finite state machine to process the input; and
determining, by the processor and by using the instance of the plurality of instances of the finite state machine, a scalar data corresponding to the input.

14. The method of claim 13, wherein the configuration comprises a description of one or more mandatory attributes for data collected by each of the plurality of instances of the finite state machine.

15. The method of claim 13, wherein the configuration comprises a description of a maximum number of scalar values for each of the plurality of instances of the finite state machine to return.

16. The method of claim 13, wherein determining the instance of the plurality of instances of the finite state machine to process the input comprises comparing the input to a value in the configuration.

17. A method, comprising:
generating, by a processor and based on a configuration, a first instance of a finite state machine to collect one or more scalar data via a dialog system;
generating, by the processor and based on the configuration, a second instance of the finite state machine that corresponds to a complex data comprising the one or more scalar data;
determining, by the process or and by using the first instance of the finite state machine, the one or more scalar data; and
transmitting, by the processor and to the second instance of the finite state machine, the one or more scalar data.

18. The method of claim 17, further comprising, performing, by the second instance of the finite state machine and based on the one or more scalar data, a backend access.

19. The method of claim 17, wherein the configuration comprises a maximum number of scalar values for the first instance of the finite state machine to return and a maximum number of scalar values for the second instance of the finite state machine to return.

20. The method of claim 17, wherein the configuration comprises:
instructions for the second instance of the finite state machine to access a database; and
a maximum number of candidates for the second instance of the finite state machine to retrieve from the database.
